(19) United States
(12) Patent Application Publication
(10) Pub. No.: US 2026/0268021 A1
(43) Pub. Date: Sep. 10, 2026

(54) Artificial Intelligence Systems and Methods for Configurable Retrieval-Augmented Generation Chatbots

(71) Applicant: Flexible Architecture and Simplified Technology Inc., Jersey City, NJ (US)

(72) Inventors: Abhay Shah, Hillsborough, NJ (US); Nicolette Kontor, South Amboy, NJ (US); Yadvaindera Sood, Iselin, NJ (US); Martin LoBiondo, Verona, NJ (US); Thomas Famularo, Freehold, NJ (US)

(73) Assignee: Flexible Architecture and Simplified Technology Inc., Jersey City, NJ (US)

(21) Appl. No.: 19/559,338

(22) Filed: Mar. 6, 2026

Related U.S. Application Data
(60) Provisional application No. 63/767,777, filed on Mar. 6, 2025.

(51) Int. Cl. G06F 21/62; G06F 16/903; G06F 16/906

(52) U.S. Cl. CPC G06F 21/6254; G06F 16/90335; G06F 16/906

(57) ABSTRACT

Artificial intelligence systems and methods for configurable retrieval-augmented generation (RAG) chatbots are provided. The system receives inputs into a chatbot platform and uses a series of processes to retrieve and generate relevant and accurate responses to user inquiries. The system conducts a security check to identify personally identifiable information and protects such information, and consults a query database to retrieve lists of confidently answerable questions through various semantic search and RAG processes which utilizes the most appropriate query to optimize the chatbot's output. A classification and sub-classification process determines what type of contextual data sources from which to retrieve data. The system generates and displays a response to the user in an interactive chatbot user interface.

### RELATED APPLICATIONS

The present application claims the benefit of U.S. Provisional Application Ser. No. 63/767,777 filed on Mar. 6, 2025, the entire disclosure of which is expressly incorporated herein by reference.

### BACKGROUND

### Technical Field

The present disclosure relates to artificial intelligence systems and methods. More specifically, the present disclosure relates to artificial intelligence systems and methods for configurable retrieval-augmented generation (RAG) chatbots.

### Related Art

In the fields of machine learning and generative artificial intelligence (AI), chatbots have become increasingly powerful and capable of generating useful responses to a wide variety of user queries. Generative artificial intelligence chatbots are large language models (LLMs) that simulate human conversations by generating responses to queries that are fed to the chatbot in various forms, typically in the form of textual queries issued by the user. Examples of successful chatbots to date include the ChatGPT chatbot by OpenAI, the Gemini (formerly Bard) chatbot developed by Google, as well as other chatbots.

Retrieval-Augmented Generation (RAG) chatbots are a type of chatbot that combines traditional generative AI chatbot features along with information retrieval technology, so as to provide more accurate and relevant responses to user queries than traditional chatbots. In a RAG chatbot, the user input (query) is first utilized to attempt to retrieve a response to the query from a data source (e.g., database or other source). Then, the user's query as well as any relevant results from the database are sent to a conventional chatbot, which utilizes the query, the results, and its own knowledge (embedded in the LLM via training) to generate a more accurate response to the user's query than conventional chatbots.

One drawback of existing RAG chatbots is that they cannot easily be configured or adapted for use in cases where there is a plethora of different types of user inputs, such as images and videos, in addition to conventional text inputs. Additionally, they cannot easily be configured and deployed in various user workflows, such that they can flexibly adapt to new technologies or changing workflow requirements. Still further, existing RAG chatbots do not provide adequate detection and protection of personally-identifiable information (PII).

Accordingly, what would be desirable are artificial intelligence systems and methods for configurable retrieval-augmented generation chatbots which address the foregoing and other needs.

### SUMMARY

The present disclosure relates to artificial intelligence systems and methods for configurable retrieval-augmented generation (RAG) chatbots. The system receives inputs into a chatbot platform and uses a series of processes to retrieve and generate relevant and accurate responses to user inquiries. The system conducts a security check to identify personally identifiable information and protects such information. The system consults a query database to retrieve lists of confidently answerable questions through various semantic search and RAG processes which utilizes the most appropriate query to optimize the chatbot's output. The system uses a classification and sub-classification process to interact with a prompt template warehouse to determine what type of contextual data sources from which to retrieve data. The system uses the searches and retrievals to generate and display a response to the user in an interactive chatbot user interface. The user then has the option of providing feedback and follow-up with any additional questions in the interactive chatbot user interface.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating the system of the present disclosure;

FIG. 2 is a flowchart illustrating overall processing steps carried out by the system of FIG. 1;

FIG. 3 is a flowchart illustrating step 34 of FIG. 2 in greater detail;

FIG. 4 is a flowchart illustrating step 36 of FIG. 2 in greater detail;

FIG. 5 is a diagram illustrating various functions and tailored responses capable of being generated by the system of FIG. 1;

FIGS. 6-7 are flowcharts further illustrating processing steps carried out by the system of FIG. 1;

FIG. 8 is a screenshot of a chat history user interface screen generated by the system;

FIG. 9 is a screenshot of a user interface screen for allowing user feedback on responses generated by the system;

FIG. 10 is a screenshot illustrating video responses capable to being generated by the system;

FIG. 11 is a screenshot illustrating textual responses generated by the system based on historical records (“log” files) of user activity;

FIG. 12 is a screenshot illustrating responses generated by the system based on operational data; and

FIGS. 13-15 are screenshots illustrating processing of metadata by the systems and methods of the present disclosure.

### DETAILED DESCRIPTION

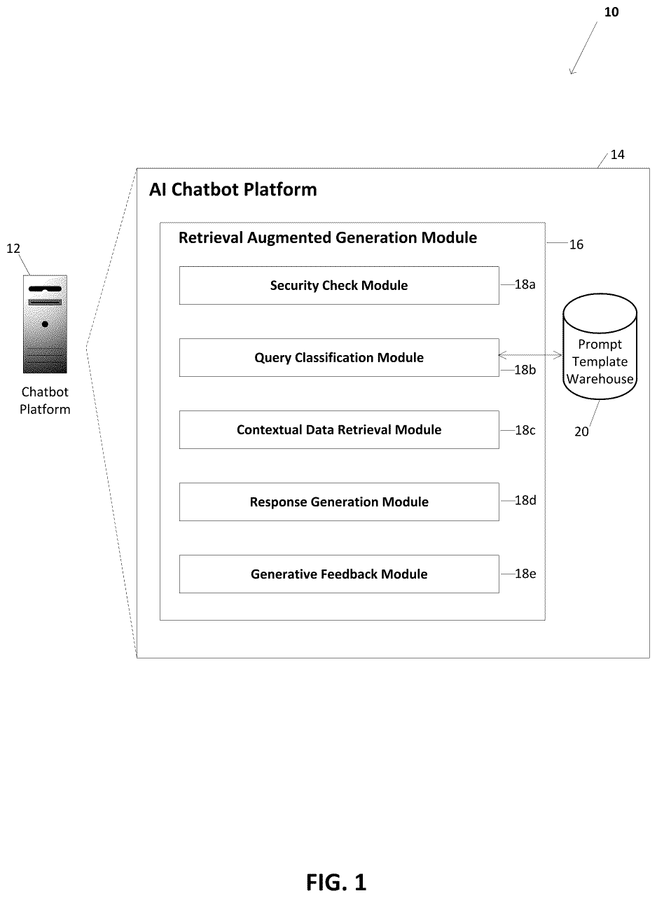

The present disclosure relates to artificial intelligence systems and methods for configurable retrieval-augmented generation chatbots, as described in detail below in connection with FIGS. 1-15.

Turning to the drawings, FIG. 1 is a diagram illustrating the system of the present disclosure, indicated generally at 10. The system includes a chatbot processor 12 that executes an AI chatbot platform 14 which includes a variety of software modules discussed herein in detail. The processor 12 can include, but is not limited to, a cloud computing platform, a server, a personal computer, a smart phone, a cloud computing device or platform, a microprocessor, or any other suitable computing device programmed to carry out the processes disclosed herein. Still further, the processor 12 can be embodied as a customized hardware component such as a field-programmable gate array (“FPGA”), an application-specific integrated circuit (“ASIC”), an embedded system, or other customized hardware component without departing from the spirt or scope of the present disclosure. The system is highly configurable and can be easily reconfigured, modified, adjusted, replaced, and/or enhanced as needed. It should be understood that the FIG. 1 is only one potential configuration, as the system may also be adapted to integrate various artificial intelligence services or models to evolve alongside advancement in artificial intelligence technologies.

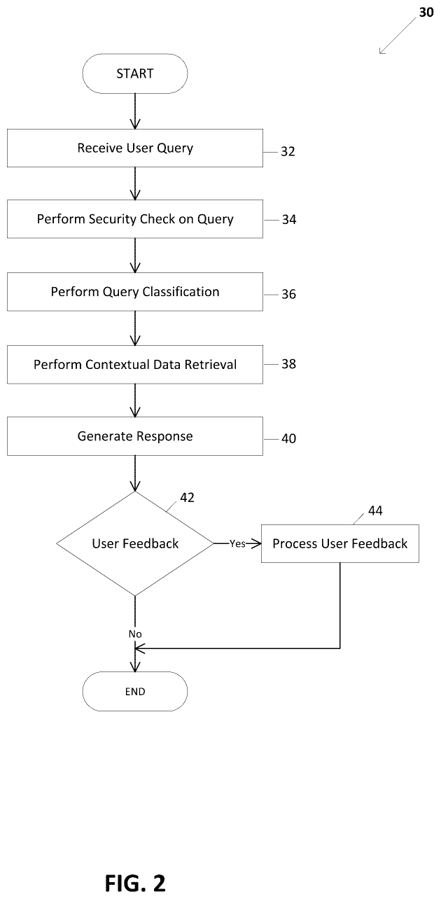

The AI chatbot platform 14 is a software-based Retrieval Augmented Generation (RAG) software system programmed and configured in accordance with the systems and methods of the present disclosure and includes a RAG module 16. The RAG module 16 includes a plurality of software modules including a security check module 18a, a query classification module 18b, a template selection and application module from prompt template warehouse 20, a contextual data retrieval module 18c, a response generation module 18d, and a generative feedback module 18e. The processes performed by each of these modules is explained in greater detail below in connection with FIGS. 2-7. The platform 14 and the RAG module 16, including the various modules 18a-18e and 20, could be coded in any suitable high-or low-level computer programming language, including, but not limited to, C, C++, C #, Java, Python, or any other suitable programming language.

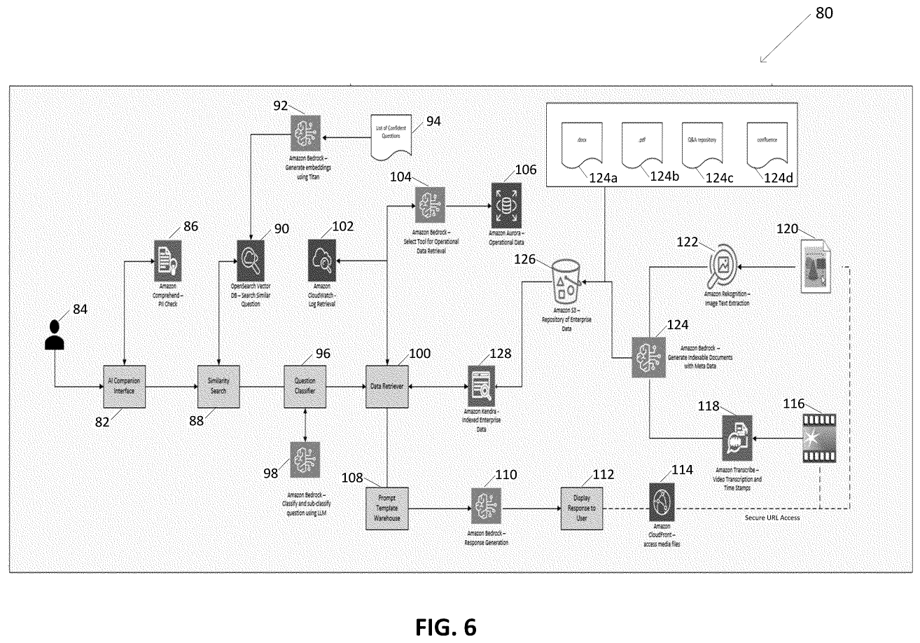

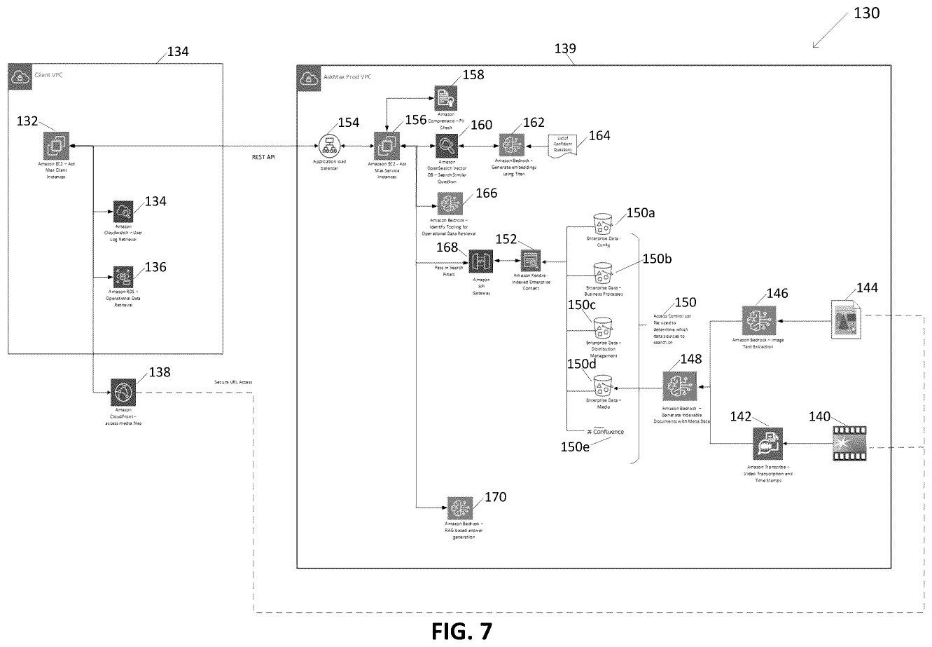

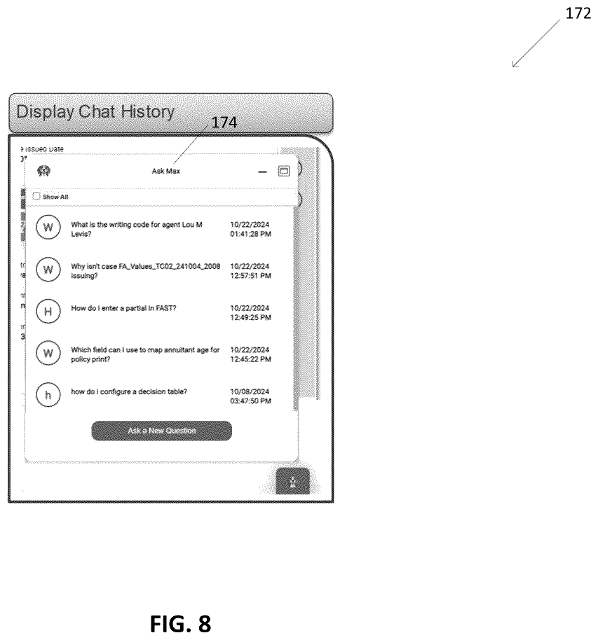

FIG. 2 illustrates overall processing steps, indicated generally at 30, carried out by platform 14. Beginning in step 32, the system receives a query from a user. The user query may be input in a chatbot interface similar to that illustrated in FIGS. 8-12. Examples of queries include queries relating to one or more business processes, business configuration queries, and other types of queries. As will be discussed in greater detail in connection with FIGS. 6-7, the user queries could be textual in nature, but could also include multimedia inputs such as images, videos, audio input, or other types of input. In step 34, the system performs a security check on the query to detect the presence of personally identifiable information (PII) in the query before preventing such information from being accessed by users without sufficient permission. Next, in step 36, the system performs a query classification on the query input by a user or an LLM capable of generating a query similar to that of an human user. The system then performs contextual data retrieval in step 38. In step 40, the system generates a response to the user query. In step 42, the system presents the user with an opportunity to provide feedback. User feedback is beneficial to the machine learning process, because it informs the system on whether or not its output is relevant and/or accurate. If a positive determination is made to provide feedback, the system continues on to step 44. In step 44, system processes the user feedback before concluding the RAG process for the current user query. Alternatively, if a negative determination is made in step 42, then the system concludes the RAG process for the current user query. Each step described above may be modified as needed for each individual user.

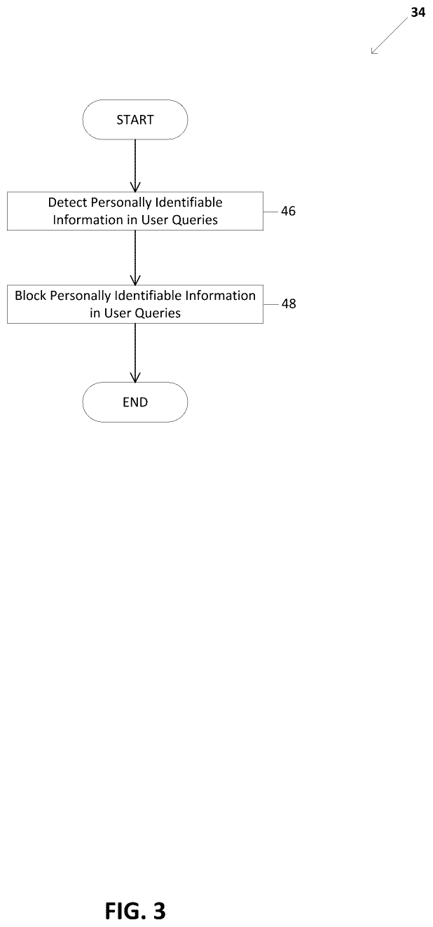

FIG. 3 is a flowchart illustrating step 34 of FIG. 2 in greater detail. In step 46, the security check performed by the system, whereby the user's query is analyzed to detect whether personally identifiable information (PII) exists in the query. Then, in step 48, the system blocks access to the PII using a variety of security measures, such as blocking user access to resources including such PII (e.g., documents, databases, logs, etc.), preventing inclusion and/or display of PII in responses generated by the system, or by other means. PII can include any information that allows the identity of an individual to whom the information applies to be identified or reasonably inferred by direct or indirect means. For example, direct identification markers could include names, addresses, social security numbers, other identifying codification, telephone numbers, and/or email addresses. Indirect identification markers could include other data elements associated with specific parties. These data elements can include any combination of factors such as gender, race, birth date, geographic indicator, and other descriptors. Detecting and blocking PII from being accessible to users who do not have the proper authorization prevents harmful data harvesting and data misuse ranging from invading other users'privacy to the fraudulent misuse and/or theft of data. Thus, the system optimizes the search process while safeguarding the PII of users and other entities.

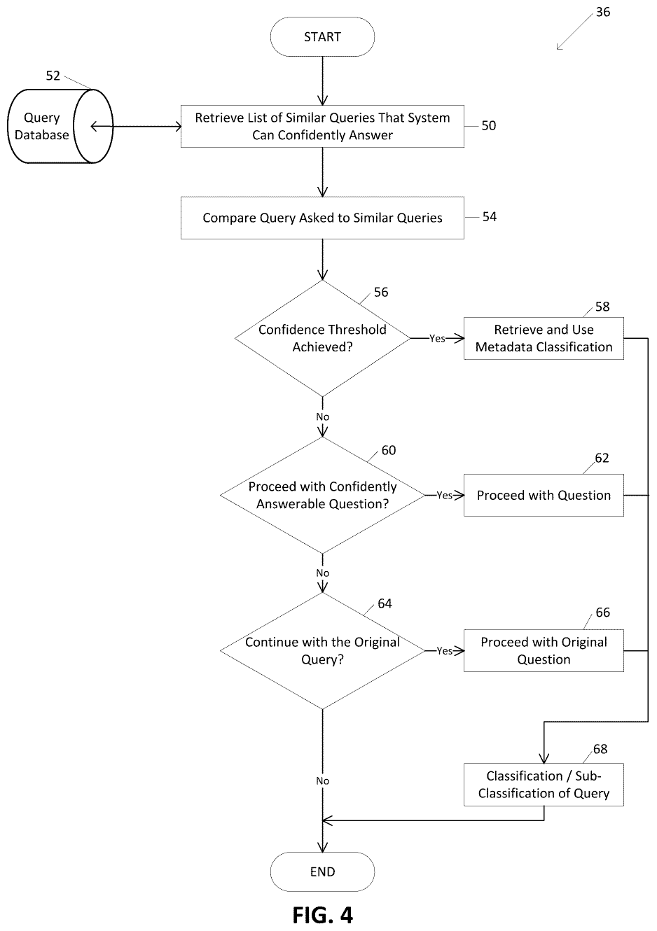

FIG. 4 is a flowchart illustrating step 36 of FIG. 2 in greater detail. The query classification process begins in step 50, wherein the system retrieves a list of similar queries from a query database 52 that the system can confidently answer. The list of similar queries increases the probability of the system sourcing accurate data for the chatbot output because it allows the system to engage in a semantic search rather than a specific search that only includes the user's original phrasing. Next, step 54 occurs, wherein the system compares the query asked by the user to the list of similar queries identified in step 50.

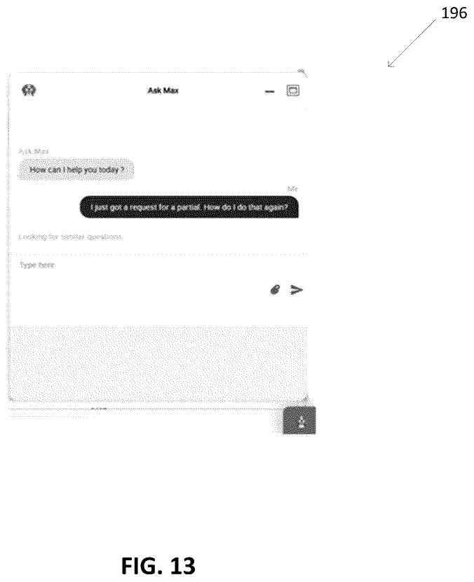

In step 56, the system makes a determination as to whether a confidence threshold has been reached for the comparable queries retrieved in step 50. If the system makes a positive determination (indicating that the system believes that the list of questions is sufficiently similar and helpful to source relevant data) then step 58 occurs. In step 58, the system retrieves and uses metadata from the similar queries for classification before continuing on to step 68. Examples of how the system processes such metadata are described below in connection with FIGS. 13-15. By retrieving metadata for the queries, the system is able to carry out PII detection functions for the comparable questions similarly to the way it did previously with data generated by the original user query.

In step 68, the system may then classify and sub-classify the confidently answerable questions retrieved before concluding the query classification process.

Alternatively, if the system makes a negative determination in step 56, the system continues on to step 60. In step 60, a determination is made as to whether to proceed with using the confidently answerable question even though the system's confidence threshold was not reached. If a positive determination is made, step 62 occurs, wherein the system proceeds to use the confidently answerable question despite not meeting the confidence threshold in step 56. The system may then proceed on to step 68, discussed above. If a negative determination is made in step 60, then step 64 occurs, a determination is made as to whether to use the original query from step 32 instead of using one of the confidently answerable questions. If a positive determination is made, the system can continue on with the original user query. The system may then proceed on to step 68, discussed above. If a negative determination is made in step 64, then system processing ends.

The query classification and sub-classification step 68 can be performed using one or more machine learning models, artificial intelligence models, and/or large language models (LLM) to perform classification, which allows the system to make a determination as to whether a query is document-related, database-related, or if it results in operational errors. If the query is document-related, the system may initiate a multi-step process that can include keyword-based retrieval before conducting a query to locate other shorter, but relevant, documents. The system can call a search service, such as Kendra, to conduct sophisticated semantic searches. Note that service calls are not limited to Kendra, and may also include other search services that run in tandem with retrievers and large language models (LLMs) to enhance the chatbot's responses and the overall user experience. These semantic searches can retrieve relevant context from resources such as, but not limited to, enterprise documentation management systems.

If the system was fed a query that is not document-related, the system ascertains whether the query is database-related. If there is a subsequent positive determination, and the query is database-related, system can communicate with an LLM to select a tool to commence data retrieval from the database. The large language model may select a tool such as, but not limited to, application programming interfaces (APIs), reports, or structured query language (SQL) queries. These tools can communicate with the database in a programming language that it understands, and may then display the requested database objects in platform 14 in a language that is more coherent and natural to users. This capability allows the system to process conversational queries without requiring an end user to be proficient in structured query language (SQL) syntax or any underlying database structures. If the query may result in an operational error, the system can retrieve the last five minutes of a user's log activity. By fetching this activity, the system may reevaluate the user's query and optimize its contextual data retrieval process to successfully yield more desirable data.

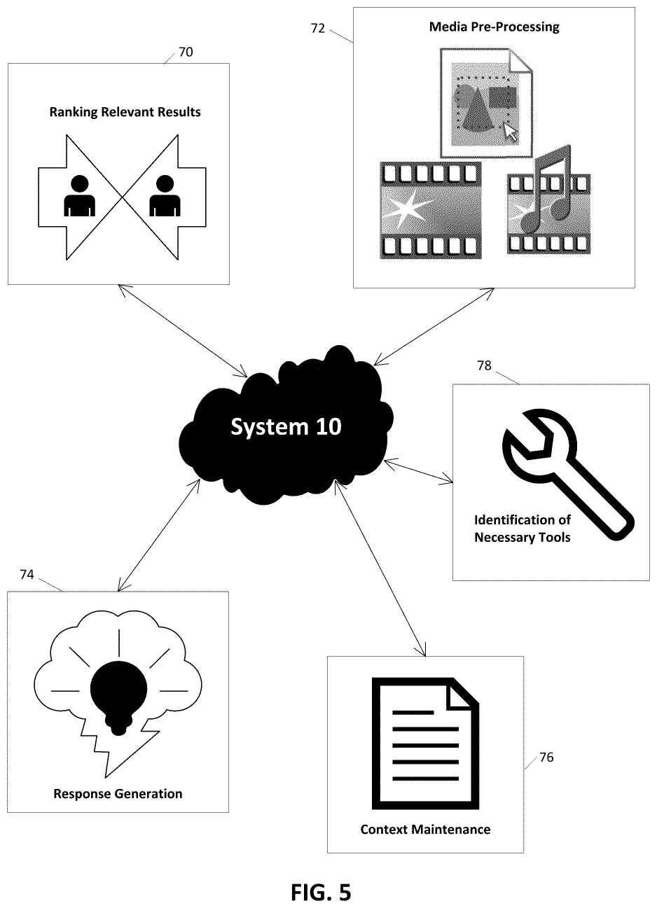

FIG. 5 is a diagram illustrating various functions and tailored responses capable of being generated by the system of FIG. 1. The system can utilize artificial intelligence systems, such as LLMs, to help perform multiple functions. For example, in result ranking process 70, the system can utilize pre-processed images and videos for real-time retrieval response and generation. Process 70 allows the system to communicate with artificial intelligence (AI), and ensures that raw data contained within documents and operational databases are formatted for analysis by such models. Improperly formatted raw data can contribute to the system experiencing poor data retrieval outcomes. Additionally, the system may also rank the relevance of the results that it has fetched.

It is noted that pre-processing and retrieval response and generation are two distinct processes that are carried out by the systems and methods of the present disclosure. Pre-processing involves preparing various types of data for indexing and later retrieval, and occurs prior to handling of user queries. Examples of such processes include: processing images (e.g., using Amazon Rekognition or an LLM) to review text, analyze visuals, and describe images; transcribing videos with Amazon Transcribe, including timestamp generation; and using an LLM (such as Claude, via Amazon Transcribe) to generate natural language descriptions of images and summarize video transcripts with the appropriate timestamps. The outputs of these pre-processing steps are then indexed in Amazon Kendra or a similar service to make them searchable. Thereafter when a user submits a query, the system performs retrieval and response generation steps, which could include: using Amazon Kendra or similar service to search the indexed data and retrieve relevant context; executing a multi-step query process; and passing the retrieved context along with the user's query to the LLM for response generation. Pre-processing happens in advance to prepare the data, while retrieval and response generation occur in real-time when handling user queries.

In media pre-processing process 72, the system ranks the data retrieved in order from most relevant to least relevant, so that the end user is able to interact with data that accurately suits their needs. The system also uses AI to identify the appropriate tools or queries for data retrieval. In response generation process 74, the system is able to communicate with AI systems to translate natural language queries into technical languages, such as structure query language (SQL) queries, to retrieve relevant data, before using such tools to translate them back into comprehensible natural language results in the chatbot. The system may also use its interaction with ML systems to summarize conversations for context maintenance. In context maintenance process 76, conversation summarization and context maintenance may enhance data retrieval by referencing past chatbot interactions. Process 76 can lead to a decrease in repetitious data retrieval, increased accuracy in chatbot results, an increase in iterative clarification that can eliminate the ambiguities that result in irrelevant data retrieval, and an increase in long-term accuracy due to familiarity with the user's past interactions with the chatbot. In tool identification process 78, the system is able to generate responses that are relevant and reliable based on the user's query and/or history of queries, using one or more suitable AI/ML refinement processes/tools.

FIG. 6 is a flowchart further illustrating processing steps carried out by the system of FIG. 1. In step 82, the user 84 inputs a query into a suitable user interface, such as an AI companion interface. The system then proceeds on to step 86 where it conducts a PII check through a natural language processing service such as Amazon Comprehend or other suitable service. Step 86 allows for managing system security and ensuring that each user has the authorization to access the information retrieved by the system.

The system continues on to step 88 where it conducts a similarity search. To conduct the similarity search, the system consults vector database 90. Vectors are data points that capture the meaning and context of system assets such as, but not limited to, operational logs, text documents, media files, and/or spreadsheets. These vectors allow search tools, such as the system's chatbot, to locate similar assets by establishing access to broader pools of data in searchable databases. Tools such as the system's chatbot take these vectors, embedded with semantic search meanings, and search them using k-nearest neighbors functionality for neighboring data points to optimize the system's RAG outputs. These vector databases behave similarly to knowledge bases, and enhance data retrieval by pulling from larger data stores to ensure that the confidently answerable questions generated are dependable, accurate, and reach an arbitrary standard of sufficient similarity. Vector database 90 can interact with a server-less service, such as Amazon Bedrock, that supplies high-performance foundational models. High-performance foundational text embedding model 92, such as Amazon Titan or any suitable alternative, converts semantic queries, such as the list of confidently answerable questions 94, into numerical representations and vectors. This conversion benefits the system's similarity search in step 88 by contributing to the raw data retrieval process occurring based on interactions between vector database 90, text embedding model 92, and the list of confidently answerable questions 94.

The system continues on to step 96 where it classifies the questions that were generated and optimized during the similarity search process. During question classification and sub-classification process 98, the system interacts with LLMs and foundational model suppliers such as Amazon Bedrock or other suitable equivalents. During classification and sub-classification process 98, the system communicates with LLMs to classify and sub-classify the list of confidently answerable questions 94 as document-related, database-related, or queries that returned some type of operational error.

In step 100, the system retrieves data based on question classification and sub-classification 98. If the system determines that the user's query resulted in an operational error, the system can use a service such as Amazon Cloudwatch to perform a log data retrieval process 102 based on the user's activity in the system. Based on the question classification, the system utilizes a foundational model provider, such as the Amazon Bedrock service, to select the appropriate foundational model tool to administer operational data retrieval in process 104. The system then proceeds to interact with a fully-managed relational database engine 106. This can include relational database such as Amazon Aurora or any similar, suitable alternative relational database engine. Here, relational database engine 106 generates contemporaneous data about the user's log activity while minimizing the necessity of the chatbot maintaining complex pipelines of data between its services, servers, and databases.

If the system determines that the user inquiry is document-related, it can perform step 108. During step 108, the system accesses a prompt template warehouse. The prompt template warehouse interacts with a foundational model service such as Amazon Bedrock to choose the proper tool in response generation process 110. Response generation process 110 utilizes appropriate tools from a foundational model service, alongside the system's LLMs, for response generation. In step 112, the system generates and displays responses in the user's interactive chatbot interface.

The system can also determine that a query is document-based or database-related, and process such types of queries. In so doing, the system can evaluate data points within various documents or data points throughout the system's databases to generate an appropriate response to the user's query. The system can use secure URL access to connect to a cloud delivery network, such as Amazon Cloudfront, to access and deliver media files to the end user. The system selects a media file, such as video file 116, before using AI alongside a service such as Amazon Transcribe, for video transcription and time stamp generation in process 118. Alternatively, the system can select a media file such as image 120 before using a service, such as Amazon Rekognition, to conduct image text extraction in process 122. Image text extraction process 122 allows the system to convert data from media images into textual data can be processed by the artificial intelligence models. As noted above, the system performs both pre-processing of input data (in advance of handling user queries), as well as real-time media retrieval and ranking in response to user queries.

Once the system has chosen, analyzed, extracted, and converted the applicable media files, it can proceed to use a service such as Amazon Bedrock during indexable document retrieval process 124. Examples of indexable documents include: .docx (Microsoft Word) processing file 124a; portable document file (PDF) 124b; question and answer repository 124c; and shared team workspaces 124d. An example of a shared team workspace that the system can use for generation could include Atlassian's Confluence software system. These indexable documents typically contain metadata. The system can link the indexable documents 124a-124d to an enterprise data repository 126. By linking the indexable documents to a data repository such as Amazon S3, specifically within a bucket in Amazon S3, the system is able to quickly and efficiently source various data points and metadata from high-performance caches, and display the desired data outputs to the user. The system can then use enterprise search engine 128 to display permissions-aware responses from enterprise data repository 126. This feature is beneficial because an enterprise search engine such as Amazon Kendra can source, display, and cite the information that the user needs while omitting any PII that the user is not authorized to view. Note that the steps within the system are re-configurable, and can be modified based on the system's needs. Thus, document-based and database-related processes may be carried out before operational log errors—and vice versa.

FIG. 7 is a flowchart that further illustrates the steps carried out by the system of FIG. 1. An instance can be a virtual machine that runs a workload in a cloud. The system can use client virtual private cloud 134 to host customizable resources such as servers, virtual machines, and services. The system uses virtual server 132, or any virtual server such as Amazon Elastic Compute Cloud (EC2), to eliminate the need for on-site hardware. This allows the system to run efficiently on cloud-based services. The system can conduct log data retrieval process 134 through a service such as Amazon Cloudwatch. This service monitors various platforms and services throughout the system. This continuous monitoring facilitates a seamless data retrieval process within the system, and for the end user, by interacting with the chatbot. Ultimately, log data retrieval process 134 allows the system to optimize outputs after detecting operational errors. This allows the system to initiate operational data retrieval process 136. A web service such as Amazon Relational Database Service (RDS), or any other suitable alternative, manages and executes common database administration tasks such as operational data retrieval 136. After the system has fetched operational data for the user, it may operate outside of the virtual private cloud (VPC) and use a content delivery network such as Amazon CloudFront to access media file 138. The system then uses secure URL access to source video media file 140. In conjunction with AI, the system then uses a service such as Amazon Transcribe to implement video transcriptions and video time stamps generation process 142. Alternatively, the system may use secure URL access to locate image media file 144. If the system sources an image media file, it can use a server-less service, such as Amazon Bedrock, to conduct image text extraction process 146. Image text extraction process 146 allows the system to convert data from media images into textual data that can be processed by ML models. Then, the system uses a service such as Amazon Bedrock for indexable document generation process 148. Indexable documents typically contain metadata that helps the system achieve accurate retrieval based on the user's query.

The system can analyze Access Control List file 150, thus allowing the system to make a determination as to which data source to search to locate ancillary data. This data source search may occur during steps 150a-150e through the previously-established enterprise data management structure. Enterprise data typically includes all of the data to which an organization has access. It can be managed and sorted in a way to efficiently carry out business processes, allow AI to make critical decisions, and streamline data retrieval for systems such as the system. After indexable document generation 148, the system accesses media enterprise data 150d using previously-generated indexable documents from media files such as videos and images. Alternatively, if the system generated indexable metadata from a different type of data (e.g., one that involved data cross-referencing for a business process), the system can search through business process enterprise data 150b. Likewise, the system could access and search configuration enterprise data 150a or access and search data from shared workspaces in from ATLASSIAN Confluence application 150e. The system then accesses a high-accuracy index 152 for RAG use cases through a service such as Amazon Kendra. This high-accuracy index can unify the search and retrieval user experience by connecting data repositories and using the metadata sourced from previous processes to optimize the user's search queries. As noted above, the system performs both pre-processing of input data (in advance of handling user queries), as well as real-time media retrieval and ranking in response to user queries.

Because the system is highly configurable, step application load balancer 154 can occur after interfacing with virtual server 132 which allows for a seamless cloud experience. The interaction between virtual server 132 and application load balancer 154 allows the system to access a virtual private cloud through a representational state transfer (REST) application programming interface (API). In turn, application load balancer 154 helps load-balance heavy HTTP and HTTPS traffic. The system can use virtual server 156, or any server including or similar to Amazon (EC2), to eliminate the need for on-site hardware. This allows the system to run efficiently on cloud services. The system can continue on to run PII check process 158. The system can use a natural language processing service such as Amazon Comprehend to run PII check process 158 to filter and block confidential information from the user if they are not authorized to access that PII.

The system can interface with vector database 160 to search instances on virtual server 156 using k-nearest neighbors functionality within a vector database such as OpenSearch. A vector database behaves similar to a knowledge base. Knowledge bases can enhance data retrieval and pull from larger stores of data to ensure that the confidently answerable question generated by the system achieves its arbitrary standard of acceptable sufficient similarity. Optionally, the system could use a server-less service, such as Amazon Bedrock, to choose an embedding generation tool 162. Embedding generation tool 162 could include embedding models such as Amazon Titan. Embedding generation tools can convert semantic text, such as that from the list of confidently answerable questions 164, into various types of numerical representations and vectors that ultimately facilitate the system's raw data retrieval. Alternatively, the embeddings could be hard-coded into the system, if desired.

Operational data retrieval identification tool 166 identifies the proper tool to use for operational data retrieval and generation. This tool identification process can occur within a service such as Amazon Bedrock. Identification tool 166 ensures that the system uses the most appropriate application or database for data extraction based on the user's query. Next, the system may pass search filters to pass data identified by identification tool 166 on to gateway 168. A service such as Amazon API Gateway can create, publish, maintain, monitor, and secure application programming interfaces. Services such as gateway 168 are beneficial for ensuring that VPCs and similar server-less systems can facilitate two-way communications throughout its various tools and applications. RAG-based generator 170 gathers all of the data and metadata that the system fetched, compiled, filtered, and optimized to generate a RAG-based answer to the user's query. Because the system can be configured to meet the needs of the end user, the system may run any similar RAG-based generator any time after the system runs virtual server 156 to search for instances.

FIG. 8 is a screenshot of a chatbot user interface 172 generated by the system. The interface 172 includes a chat history screen 174 that allows a user to view a log of previous questions asked by the user, as well as a button prompting the user to ask the chatbot another question.

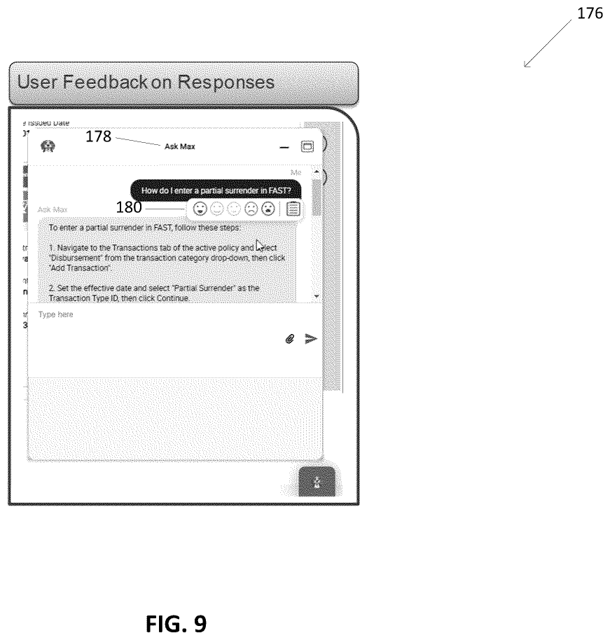

FIG. 9 is a screenshot of another user interface 176 generated by the system for allowing user feedback on text responses generated by the system. The interface 176 includes a chatbot interface screen 178 that allows the user to ask a question as well as display answers generated by the system. Emoticon feedback bar 180 allows the user to indicate the user's satisfaction level through representations such as colors (e.g., green for satisfactory and red for unsatisfactory) and expressions (e.g., smiles for satisfactory and frowns for unsatisfactory). This feedback assists the system in optimizing results and to deliver outputs that are relevant and accurate based on user inquiries and needs.

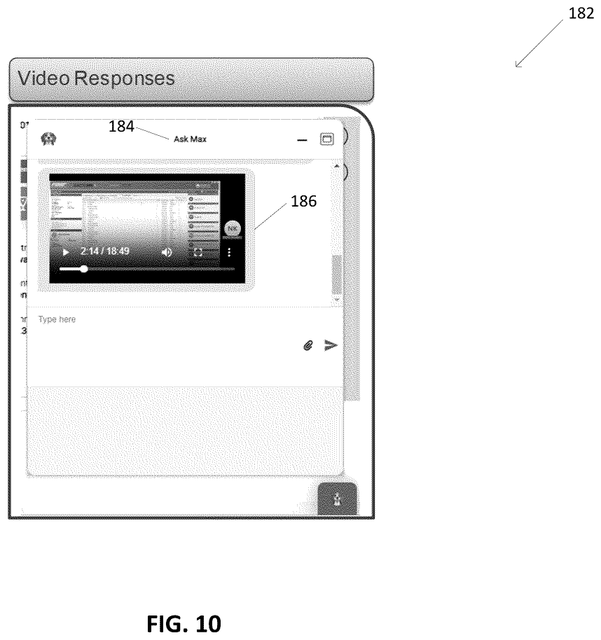

FIG. 10 is a screenshot illustrating video responses that the system is capable of generating. In user interface 182, the system fetches a video based on the user's inquiry. More specifically, chatbot interface screen 184 displays a video response 186 (e.g., video clip) generated through RAG processes in response to a user query, as well as a textbox to type in additional inquiries. In the video response 186, the user can interact and view a video clip without leaving the chatbot interface screen 184.

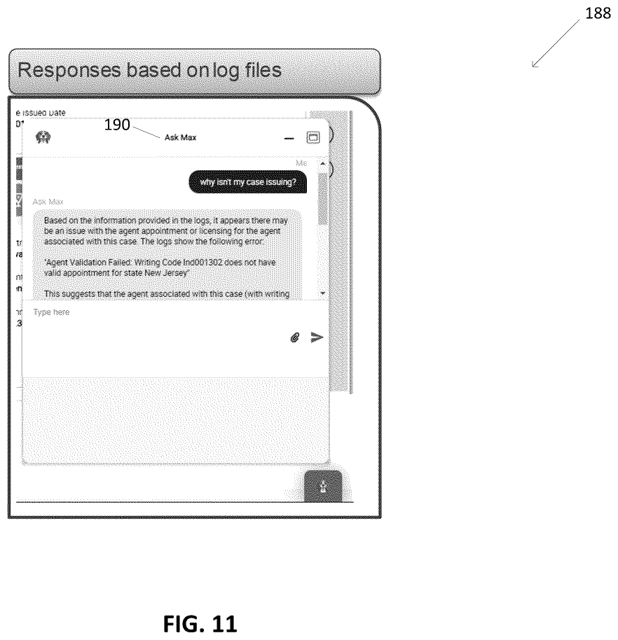

FIG. 11 is a screenshot illustrating textual responses generated by sourcing historical records (“log” files) of user activity. The system fetches log data based on the activities and needs of the user before generating and displaying a response within chatbot interface screen 190 of user interface 188. Chatbot interface screen 190 displays the log data generated through RAG processes, a textbox to type in additional inquiries, and any other features that could enhance the user experience.

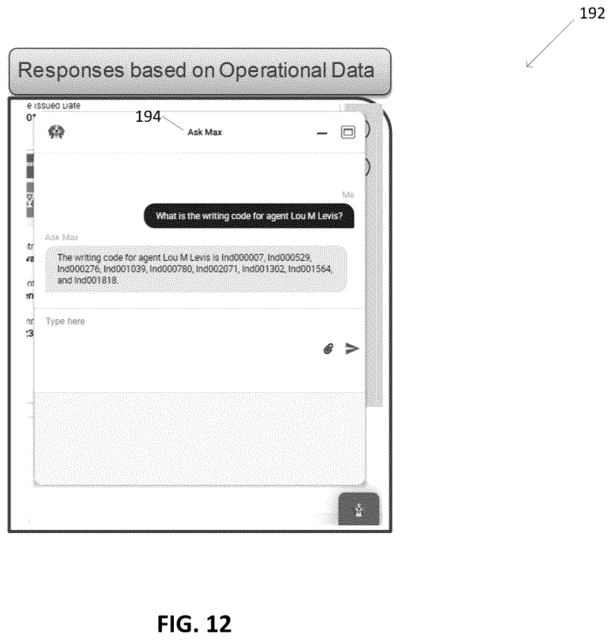

FIG. 12 is a screenshot illustrating responses generated by the system based on operational data. As noted earlier, the system analyzes its cloud storage, databases, and servers to source applicable operational data. After the system fetches the appropriate operational data, the system generates and displays responses in chatbot interface screen 194 of user interface 192. Chatbot interface screen 194 displays operational data generated through RAG processes, a textbox allowing entry of additional inquiries, and any other features that could enhance the user experience. Here, the operational data includes writing code information corresponding to an agent, but of course, other types of operational data could be generated and displayed.

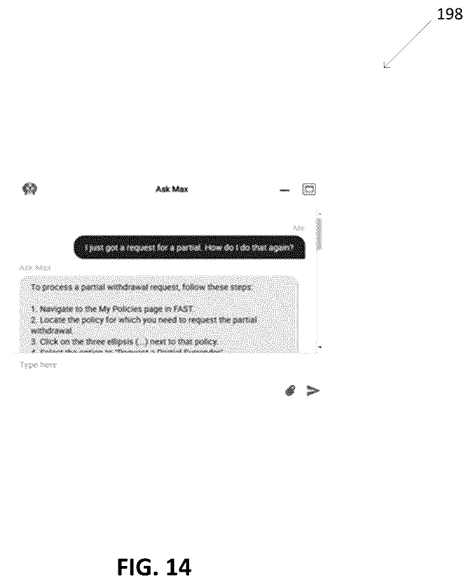

FIGS. 13-15 are screenshots illustrating processing of metadata by the systems and methods of the present disclosure. The metadata returned as part of a similar question search performed by the system includes the question text and classification indicators of the similar question. The system is then asked to score the relevance of the similar questions against the original question, and to assign a score from 1-10. The score thresholds and what they trigger are configurable. If the system scores at least one similar question with a score of HIGH_CONFIDENCE, the system will use the classification indicators of that similar question to determine the excerpts to retrieve and the prompt template to use. No user input needed. This is illustrated in FIGS. 13-14, wherein in the interface screen 196 in FIG. 3, the user asks the system a question (“I just got a request for a partial. How do I do that again?”), which is scored by the system. As shown in FIG. 14, the system has determined a high confidence score that the question is similar to one or more questions previously asked by the system, and automatically displays the response in user interface screen 198. No user input was needed (beyond the question posed by the user) in order for the system to correctly process and answer the question.

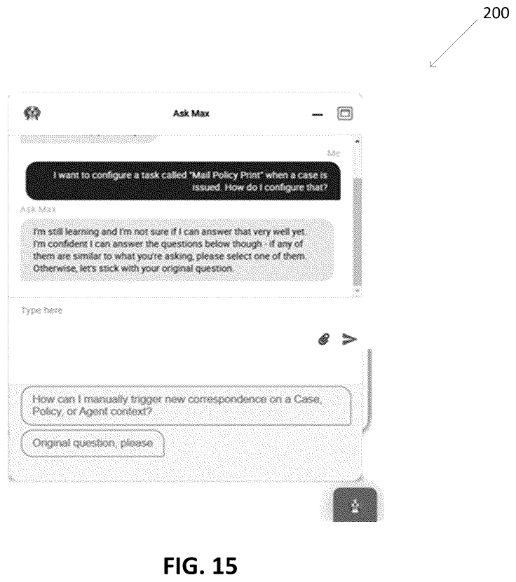

If the system returns a similar question with a score of MEDIUM_CONFIDENCE and nothing higher, the system will display the similar questions to the user to determine if they would like to proceed with a question that the system can confidently answer or proceed with the original question. This is illustrated in the user interface screen 200 of FIG. 15, wherein, in response to the question “I want to configure a task called ‘Mail Policy Print’ when a case issued. How do I configure that?”, the system identifies and displays a similar question (“How can I manually trigger new correspondence on a Case, Policy, or Agent context?”). The user can then select whether to proceed with the similar question or to proceed with the original question by clicking on the options displayed to the user. If the system returns similar questions with a score of LOW_CONFIDENCE or there are no similar questions to score, the system will proceed with classifying the original question as it is to determine the excerpts to retrieve and the prompt template to use. No user input needed.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification, including those discussed above, are intended to be included within the scope of the disclosure. What is desired to be protected by Letters Patent is set forth in the following claims.

What is claimed is:

1. An artificial intelligence (AI) system for configurable, retrieval-augmented (RAG) chatbots, comprising:
a chatbot processor executing an AI chatbot platform, the AI chatbot platform receiving a query from a user of the AI chatbot platform;
a query classification software module executed by the chatbot processor, the query classification software module: (i) querying a query database to determine whether one or more second queries exists in the query database similar to the query from the user; (ii) determining whether the one or more second queries can generate an answer having a confidence score that exceeds a pre-defined threshold; (iii) retrieving metadata from the one or more second queries if the confidence score exceeds the pre-defined threshold; (iv) determining whether the query is answerable if the confidence score does not exceed the pre-defined threshold; and (v) classifying the query using a large language model (LLM); and
a response generation software module executed by the chatbot processor, the response generation software module generating responsive data to the query based on the classification of the query by query classification software module and presenting the responsive data to the user using the AI chatbot platform.

2. The system of claim 1, further comprising a security check software module executed by the chatbot processor, the security check software module processing the query to detect the presence of personally-identifiable information (PII) in the query and preventing accessing of the PII by users of the system if the PII is detected in the query.

3. The system of claim 1, further comprising a template selection software module executed by the chatbot processor, the template selection software module accessing a prompt template for use by the system in generating the responsive data.

4. The system of claim 1, further comprising a generative feedback software module executed by the chatbot processor, the generative feedback software module allowing the user to provide feedback regarding the responsive data.

5. The system of claim 1, wherein the response generation software module generates the responsive data using one or more prompt templates based on the classification of the query by the LLM.

6. The system of claim 1, wherein the query classification software module determines whether the query is document-related, database-related, or results in operational errors.

7. The system of claim 6, wherein the system performs keyword-based retrieval of the responsive data if the query is document-related.

8. The system of claim 6, wherein the system selects an application programming interface (API) or a structured query language (SQL) query if the query is database-related.

9. The system of claim 8, wherein the system automatically retrieves the responsive data from one or more databases using the API or the SQL query.

10. The system of claim 6, wherein the system retrieves a log of user activity and optimizes contextual data retrieval if the query results in operational errors.

11. The system of claim 1, wherein the system performs a semantic search for the responsive data.

12. An artificial intelligence (AI) method for configurable, retrieval-augmented (RAG) chatbots, comprising:
receiving a query from a user of an AI chatbot platform at a chatbot processor;
executing a query classification software module by the chatbot processor, the query classification software module: (i) querying a query database to determine whether one or more second queries exists in the query database similar to the query from the user; (ii) determining whether the one or more second queries can generate an answer having a confidence score that exceeds a pre-defined threshold; (iii) retrieving metadata from the one or more second queries if the confidence score exceeds the pre-defined threshold; (iv) determining whether the query is answerable if the confidence score does not exceed the pre-defined threshold; and (v) classifying the query using a large language model (LLM); and
executing a response generation software by the chatbot processor, the response generation software module generating responsive data to the query based on the classification of the query by query classification software module and presenting the responsive data to the user using the AI chatbot platform.

13. The method of claim 12, further comprising executing a security check software module by the chatbot processor, the security check software module processing the query to detect the presence of personally-identifiable information (PII) in the query and preventing accessing of the PII by users of the system if the PII is detected in the query.

14. The method of claim 12, further comprising executing a template selection software module by the chatbot processor, the template selection software module accessing a prompt template for use by the system in generating the responsive data.

15. The method of claim 12, further comprising executing a generative feedback software module by the chatbot processor, the generative feedback software module allowing the user to provide feedback regarding the responsive data.

16. The method of claim 12, wherein the response generation software module generates the responsive data using one or more prompt templates based on the classification of the query by the LLM.

17. The method of claim 12, wherein the query classification software module determines whether the query is document-related, database-related, or results in operational errors.

18. The method of claim 17, further comprising performing keyword-based retrieval of the responsive data if the query is document-related.

19. The method of claim 17, further comprising selecting an application programming interface (API) or a structured query language (SQL) query if the query is database-related.

20. The method of claim 19, further comprising automatically retrieving the responsive data from one or more databases using the API or the SQL query.

21. The method of claim 17, further comprising retrieving a log of user activity and optimizing contextual data retrieval if the query results in operational errors.

22. The method of claim 12, further comprising performing a semantic search for the responsive data.
